(19) United States
(12) Patent Application Publication
(10) Pub. No.: US 2019/0168914 A1
(43) Pub. Date: Jun. 6, 2019

(54) A TEALIGHT

(71) Applicant: KORONA CANDLES S.A., Wielun (PL)

(72) Inventor: Krzysztof JABLONSKI, Warszawa (PL)

(21) Appl. No.: 16/092,774

(22) PCT Filed: Feb. 16, 2017
(86) PCT No.: PCT/EP2017/053444

§ 371 Date: Oct. 11, 2018

(30) Foreign Application Priority Data
Apr. 11, 2016 (PL) W.125026
Apr. 11, 2016 (PL) W.125027

(51) Int. Cl. B65D 21/02; C11C 5/00

(52) U.S. Cl. CPC B65D 21/0213; C11C 5/006; B65D 2203/02; C11C 5/008

(57) ABSTRACT

A tealight comprising a cup (110) having a base (111) and a sidewall (112), the cup (110) being filled with a flammable mass (120) in which a wick (130) is positioned wherein the outer surface of the sidewall (112) of the cup (110) is surrounded by a sleeve (140). A stack of tealights comprising at least two stacked tealights surrounded by the sleeve (140).

### TECHNICAL FIELD

The present disclosure relates to a tealight.

### BACKGROUND

A typical tealight comprises a cylindrical cup, usually made of metal (typically aluminum) or plastic, filled with a flammable mass (usually a paraffin mixture) within which a wick is positioned. A tealight of this type is disclosed, for example, in a European patent application EP2930421.

Tealights, as items of mass use, are usually sold in packages comprising between a few and a hundred of tealights. The tealights are typically arranged in stacks, and a plurality of stacks are surrounded by a foil envelope to form a single package. To unpack the package, the user makes a cut in the envelope to remove the tealight therefrom, which usually disrupts the arrangement of tealights within the envelope. As more and more tealights are removed from the envelope, it turns into a bag of loosely arranged tealights, which makes them prone to damage from the neighboring tealights, which reduces the appearance of their external surface—the outer surface of the cups may be contaminated with the flammable mass from the other tealights, and the outer surface of the flammable mass may be scratched by the cups of the other tealights.

A Polish patent PL202131 discloses a packaging made of a heat-shrink foil comprising a plurality of tealight stacks. The foil acts only as a container to store the tealights.

In typical tealights, the outer surface of a cylindrical wall of the cup has the colour of the cup material. This type of tealights does not provide any extra aesthetic values and does not allow the consumer to distinguish tealights of one provider from the others. So far, the aesthetic values of the tealights have been increased by for example coloring the flammable mass, to make the tealight more appealing to the consumer.

There is a need to provide an alternative way of providing a tealight with added aesthetic functionality. There is also a need to provide a way to provide an alternative tealight packaging.

### SUMMARY

There is disclosed herein a tealight comprising a cup having a base and a sidewall, the cup being filled with a flammable mass in which a wick is positioned, wherein the outer surface of the sidewall of the cup is surrounded by a sleeve.

The sleeve can be made of plastic.

The sleeve can be made of heat-shrinkable plastic.

The sleeve may adhere directly to the outer surface of the sidewall of the cup.

The sleeve can be connected with the outer surface of the sidewall of the cup by a glue layer.

The sleeve may have an overprint layer.

The sleeve may have a height (h1) equal to an outer height (H) of the cup.

The sleeve may have a height (h1) smaller than an outer height (H) of the cup.

The height (h1) of the sleeve can be not more than 50% of the height (H) of the cup.

### BRIEF DESCRIPTION OF FIGURES

The present invention is presented by means of example embodiment in a drawing, in which:

FIG. 1 presents a tealight in a perspective view;

FIG. 2 presents a first embodiment of the tealight (not in scale) in a cross-sectional view;

FIG. 3 presents a second embodiment of the tealight (not in scale) in a cross-sectional view;

### DETAILED DESCRIPTION

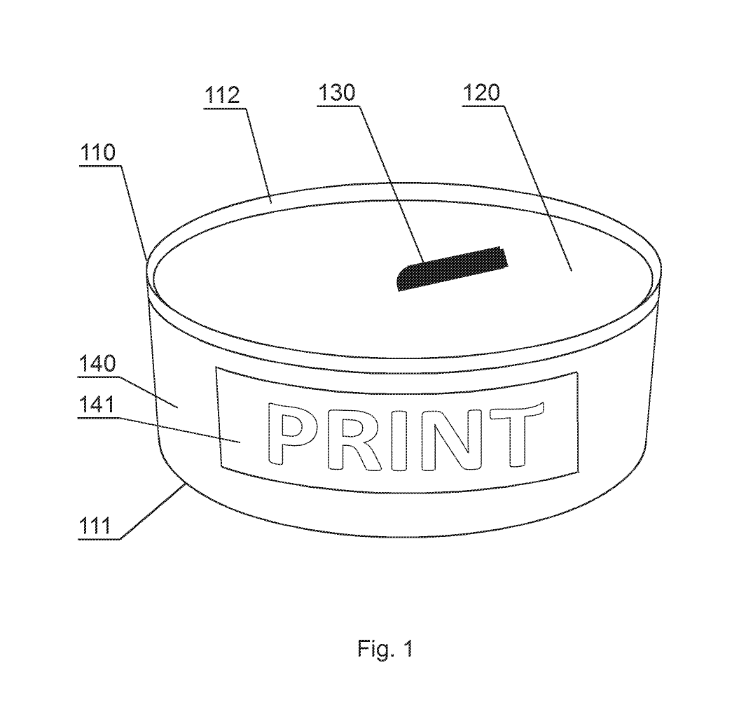

FIG. 1 shows an embodiment of a tealight. The tealight has a cup 110, which may have a round base 111 and a cylindrical sidewall 112. The cup 110 is filled with a flammable mass 120 in which a wick 130 is mounted. The distinguishing feature of that tealight is that the outer surface of the sidewall 112 of the cup 110 is surrounded by a plastic sleeve 140.

The height h1 of the sleeve 140 may be equal to the outer height H of the cup 110 or may be smaller.

Use of the sleeve 140 with the height h1 which is smaller than the height H of the cup 110, but preferably not more than 50% smaller, allows for manufacturing tolerance to produce tealights with high speeds, when the precise matching of the location of the sleeve location with respect to the can be difficult.

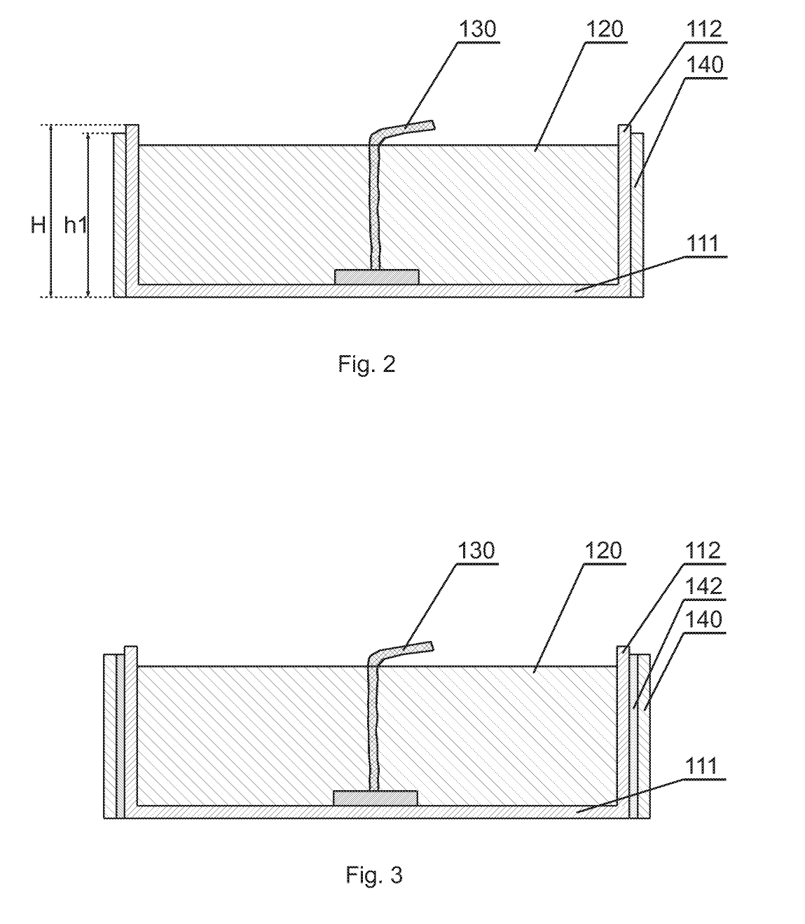

The sleeve 140 may be made of a heat-shrinkable plastic foil. To contact the sleeve 140 with the sidewall 112 of the cup 110, the sleeve may be prepared having a diameter slightly larger than the outer diameter of the cup 110, applied over the cup 110 and then heated to shrink and closely adhere to the outer surface of the sidewall 112 of the cup 110. In such embodiment, as shown in FIG. 2, the sleeve 140 adheres directly to the outer wall 112 of the cup 110.

In another embodiment, the sleeve 140 may be made of a plastic strip which is wrapped closely around the sidewall 112 of the cup 110 and its ends are connected (for example, glued or welded).

In yet another embodiment, the sleeve 140 may be made of a plastic strip which is wrapped closely around the sidewall 112 and is glued to the sidewall 112 of the cup. In such embodiment, as shown in FIG. 3, a layer of glue 142 is present between the sleeve 140 and the outer wall 112 of the cup 110.

The perforations 143 may be made in the sleeve 140 before it is applied over the cup 110, or after the sleeve is applied over the cup 110.

In order to provide additional aesthetic value to the tealight, the sleeve 140 may be made of coloured plastic. The plastic foil may be dyed in mass. The sleeve 140 may also have an overprint layer 141, with printed decorative elements. The overprint may be located on the one side or both sides of the sleeve 140. If the sleeve 140 is made of a non-transparent material, the overprint 141 should be located at the external side of the sleeve 140, i.e. the side opposite to the side contacting the sidewall 112 of the cup 110. If the sleeve is made of a transparent material, the overprint 141 may be located both at the outside and at the inside of the sleeve 140. The overprint may be made with various known printing technologies, such as inkjet printing, offset printing, etc.

As an additional advantage, the sleeve 140 reduces the thermal permeability of the cup, which makes it more convenient for the user to take a burning tealight in hand.

1. A tealight comprising:
a cup having a base and a sidewall,
a flammable mass contained in the cup,
a wick positioned in the flammable mass,
a sleeve surrounding the outer surface of the sidewall of the cup.

2. The tealight according to claim 1, wherein the sleeve is made of plastic.

3. The tealight according to claim 2, wherein the sleeve is made of heat-shrinkable plastic.

4. The tealight according to claim 1, wherein the sleeve adheres directly to the outer surface of the sidewall of the cup.

5. The tealight according to claim 1, wherein the sleeve is connected with the outer surface of the sidewall of the cup by a glue layer.

6. The tealight according to claim 1, wherein the sleeve has an overprint layer.

7. The tealight according to claim 1, wherein the sleeve has a height equal to an outer height of the cup.

8. The tealight according to claim 1, wherein the sleeve has a height smaller than an outer height of the cup.

9-12. (canceled)
